(19) United States
(12) Patent Application Publication
(10) Pub. No.: US 2004/0223638 A1
(43) Pub. Date: Nov. 11, 2004

(54) Method and an instrument for inspection of the bond between a honeycomb core and a skin

(75) Inventors: Olivier Lespinet, Corbeil Essonnes (FR); Jerome Menini, Bourron Marlotte (FR); Franck Panizzoli, Fontainebleau (FR)

Correspondence Address: OBLON, SPIVAK, MCCLELLAND, MAIER & NEUSTADT, P.C., 1940 DUKE STREET, ALEXANDRIA, VA, 22314, US

(73) Assignee: SNECMA MOTEURS, Paris (FR)

(21) Appl. No.: 10/831,137

(22) Filed: Apr. 26, 2004

(30) Foreign Application Priority Data
Apr. 28, 2003 (FR) 0305166

(51) Int. Cl. G01N 21/00

(52) U.S. Cl. 382/141; 356/237.1

(57) ABSTRACT

The method for inspection of the bond between a honeycomb core and a skin comprises the following operations:

use of a light source (15) to illuminate a so-called illuminated area (17) on the free surface (4) of the honeycomb (1),

automatically detect emerging light (21) from the cells (5) in a so-called observed area (22) also at said free surface (4),

automatically detect openings (6) of the cells (5) in a so-called photographed area (32) also at said free surface (4).

Said instrument for inspection of the bond between a honeycomb core and a skin is specially designed to implement the inspection method described above.

### DESCRIPTION

1. Technical Field

This invention relates to the technical domain of laminated honeycomb structures, called “honeycombs” for short.

It is an improvement to the method and the instrument for inspection of the bond between a honeycomb core and a skin, as defined in patent FR 2 785 388.

Remember that at one stage of manufacturing, a honeycomb is composed of a honeycomb core bonded to a skin on one of its ends. The honeycomb core is in the form of adjacent cells separated by partitions extending through the direction of the thickness of the honeycomb. The bond between the honeycomb core and the skin may be made by welding, gluing or brazing. Bond defects may occasionally occur. These defects may be isolated defects or they may be in the form of complete areas of defects. They result in the occurrence of spaces between the partitions of cells and the skin, that put the cells into communication with each other.

2. State of Prior Art

It is required to inspect the quality of the bond between the partition cells and the skin, and to detect defects in this bond.

The method and the instrument used for inspection of the bond between a honeycomb core and a skin as divulged in patent FR 2 785 388 will be briefly described, with reference to FIG. 1.

FIG. 1 shows a honeycomb 1 comprising a honeycomb core 3 composed of adjacent cells 5 delimited laterally by partitions 7, said core 3 being bonded on one side on a skin 2, while at this stage of manufacturing the other side forms a free surface 4 on which the openings 6 of said cells 5 are located.

The inspection method according to prior art includes the following operations:

use a light source 15 to illuminate a so-called illuminated area 17 on the free surface 4 of the honeycomb 1, in order to illuminate the inside of the cells 5 opening up in said illuminated area 17,

detect emerging light 21 output from the cells 5 in a so-called observed area 22 also at said free surface 4.

The inspection instrument 60 according to prior art is specially designed to implement said inspection method. It comprises:

a) a mask 26 delimited laterally by an illumination edge 27 and an observation edge 28 opposite said illumination edge 27,

b) a light source 15, placed behind the mask 25, said light source 15 being fixed to the mask 26 and producing an incident light beam 16 from the back of the mask 26 towards the front of the mask 26,

c) means 20 of detecting and signaling any light 21 emerging from the back of the mask 26 towards the front, said detection means 20 being fixed to the mask 26, said emerging light 21 passing in front of the observation edge 28.

The mask 26 is placed in contact with the free surface of the honeycomb or in the vicinity of it. A screen 29 may be fixed above it located between the light source 15 and the detection means 20. The mask 26 covers an intermediate area 25 of the free surface 4, located between the illuminated area 17 and the observed area 22. The mask 26 moves along a direction D, and performs an incremental or continuous scanning so as to pass above all the cells 5. The minimum distance between the illuminated area 17 and the observed area 22 is denoted E. It is equal to at least the width L1 of the openings 6, said width L1 being measured along the direction D.

The detection means may be simply an operator's eye. Alternately, automated detection means could be used capable of picking up a signal from light 21 emerging from incident light 16. These detection means may be associated with display means capable of reproducing an optical image of the picked up signal. FIG. 2 illustrates such an optical image obtained after scanning of the mask.

A spot 80 corresponding to a bond defect appears on the optical image. It is located between a line 27a that is an image of the illumination edge 27 of mask 26, and a line 28a that is an image of the observation edge 28 of the mask 26. The distance AB between the two lines 27a and 28a is minimum and is equal to the distance E.

The previous device has a disadvantage in that during displacement, the mask rubs against the honeycomb core at the openings of the cells due to irregularities existing on the free surface at this stage of manufacturing. Friction induces two harmful consequences; the first consequence of this friction is damage to the free surface and consequently an alteration to the qualities of the honeycomb. The second consequence of this friction is a disturbance to displacement of the mask and consequently an alteration to the performances of the method of inspecting the bond between the honeycomb core and the skin.

A solution has been provided for this disadvantage, through a variant of the inspection method according to prior art. This variant is illustrated in FIG. 3 and consists of lifting said mask 26 to a certain height H above the free surface 4. Thus, the mask no longer rubs in contact with said free surface as it moves.

If emerging light is detected by the operator's eyes, this variant in the inspection method is satisfactory.

However, if emerging light is detected by automated means, for example such as a CCD camera associated with automatic processing means for the emerging light signal, then this variant of the inspection method according to prior art has a new disadvantage. Since the mask is lifted, the detection means can detect a signal corresponding to the emerging light 21 representative of a defect 50 in the bond between the honeycomb core and the skin, but also one or several additional signals corresponding to one or several parasite reflections 18 due to the reflection of the incident light 16 on the top edges of the partitions 7 separating the cells 5. FIG. 4 shows an optical image illustrating this disadvantage. The spot 80 corresponds to a bond defect 80, while spots 90 correspond to parasite reflections 18. The result is that the inspection of the bond between the honeycomb core and the skin is not reliable, since a light signal can be detected that does not correspond to a defect in the bond between the honeycomb core and the skin.

### SUMMARY OF THE INVENTION

The purpose of this invention is to overcome the disadvantages mentioned above.

It proposes an inspection method and an inspection instrument that solve the problem of friction of the mask on the honeycomb and the problem of identification of light signals picked up by automated detection means.

According to the invention, the method for inspection of the bond between a honeycomb core and a skin, in which said honeycomb comprises a honeycomb core composed of adjacent cells delimited laterally by partitions, said core being bonded onto a skin at one side, while at this stage of manufacturing the other side forms a free surface containing the openings of said cells, comprises the following operations:

use of a light source to illuminate a so-called illuminated area on the free surface of the honeycomb, in order to illuminate the inside of cells opening up in said illuminated area,

automatically detect emerging light from the cells in a so-called observed area also at said free surface,

the minimum distance between said illuminated area and said observed area being denoted E and defining a direction D, and the distance E being equal to at least the width L1 of the openings, said width L1 being taken along the direction D.

The inspection method also comprises the operation consisting of:

automatically detecting openings in a so-called photographed area also at said free surface.

Preferably, the minimum distance between said observed area and said photographed area measured along the direction D and denoted F, is less than the width L2 of the openings of two adjacent cells.

Preferably, the inspection method also includes signal processing operations consisting of:

transforming a signal corresponding to detected emerging light into a first optical image in the form of a matrix of pixels on which spots appear representing any bond defects and spots representing parasite reflections,

transforming a signal corresponding to the detected openings into a second optical image in the form of a matrix of pixels on which contours appear.

Preferably, the inspection method also comprises an image processing operation comprising the following steps:

superpose said first optical image and said second optical image, and identify the spots on the first optical image that are at least partly superposed with the contours of the second optical image as being spots representing parasite reflections,

provide a third optical image derived from the first optical image from which spots identified as being spots representing parasite reflections have been removed.

The inspection method comprises another optional image processing operation consisting of outputting a resulting optical image that displays bond defects in a coded manner. Preferably, said resulting optical image consists of a representation of a top view of the honeycomb, on which a first color is assigned to the cells that are not affected by a bond defect, and a second color is assigned to cells that are affected by a bond defect.

According to the invention, said instrument for inspection of the bond between a honeycomb core and a skin is specially designed to implement the inspection method according to the invention, and comprises:

a) a first mask delimited laterally by an illumination edge and an observation edge opposite said illumination edge,

b) a light source placed behind the first mask, said light source being fixed to the first mask, said light source producing a beam of incident light from the back of the first mask towards the front of the first mask,

c) first means of automatically detecting emerging light in the direction from the back towards the front of the first mask, said first detection means being fixed to the first mask, said emerging light passing in front of the observation edge.

The inspection instrument also comprises:

d) a second mask fixed to the first mask and arranged in front of it at a given distance M,

e) second means of automatically detecting openings of the cells in front of the second mask, said second detection means being fixed to the second mask,

f) retaining means to hold said first mask and said second mask at a height H above the free surface.

Preferably, the inspection instrument also comprises signal processing means and image processing means associated with first detection means to perform signal processing operations, and second detection means to perform image processing operations of the inspection method.

### BRIEF DESCRIPTION OF THE DRAWINGS

The invention will be better understood after reading the following detailed description of particular embodiments of the invention, provided for illustrative purposes and in no way limitative, with reference to the attached drawings in which:

FIG. 1, already described, illustrates a sectional view of a honeycomb and a general method and an instrument according to prior art for inspection of the bond,

FIG. 2, already described, illustrates a top view of an optical image of a defect in a honeycomb, obtained using the method and instrument according to prior art;

FIG. 3, already described, shows a view similar to FIG. 1 illustrating a variant embodiment of the method according to prior art;

FIG. 4, already described, shows a view similar to FIG. 2 illustrating a top view of an optical image of a defect in the honeycomb, obtained using the variant to the method and instrument according to prior art;

FIG. 5 is a view similar to FIG. 3 for an inspection method and instrument according to the invention;

FIG. 6A illustrates a top view of an optical image showing spots representative of a bond defect and parasite reflections;

FIG. 6B illustrates a top view of an optical image showing representative contours of the opening of a cell;

FIG. 6C illustrates a top view of an optical image showing a spot representative of a bond defect obtained after an operation for processing of the optical images in FIGS. 6A and 6B;

FIG. 7 illustrates a top view of a visual representation of a honeycomb demonstrating areas affected by bond defects obtained following an additional image processing operation; and

FIG. 8 illustrates a top view of an optical image of a honeycomb defect, obtained with a variant embodiment of the inspection instrument according to the invention.

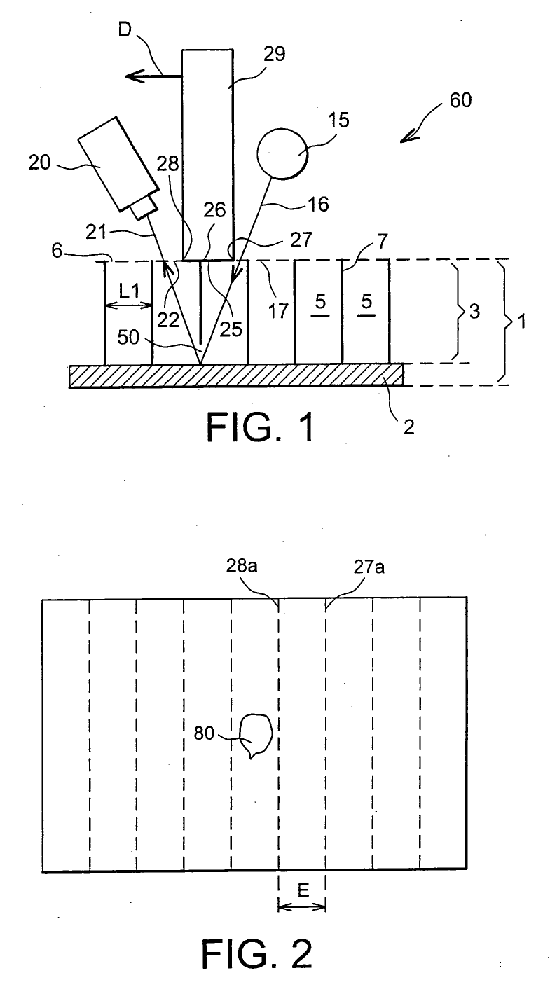

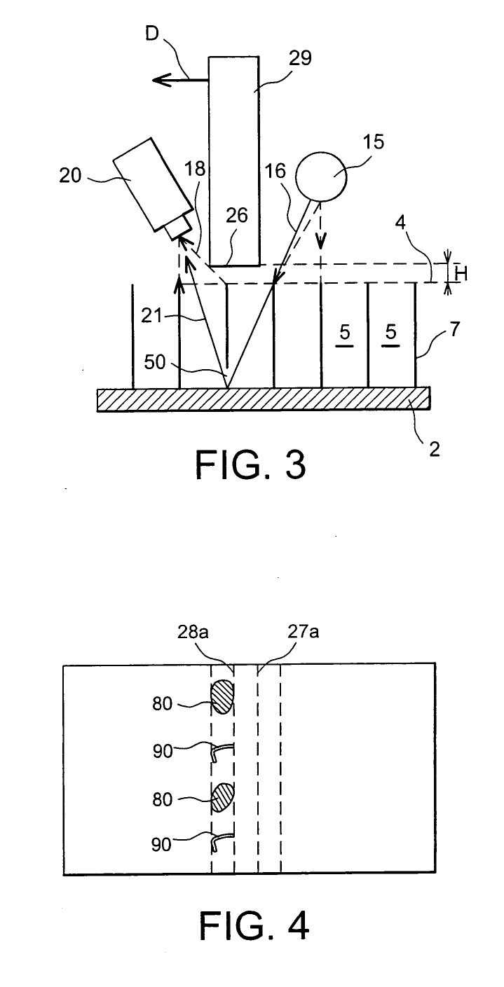

### DETAILED DESCRIPTION OF PARTICULAR EMBODIMENTS

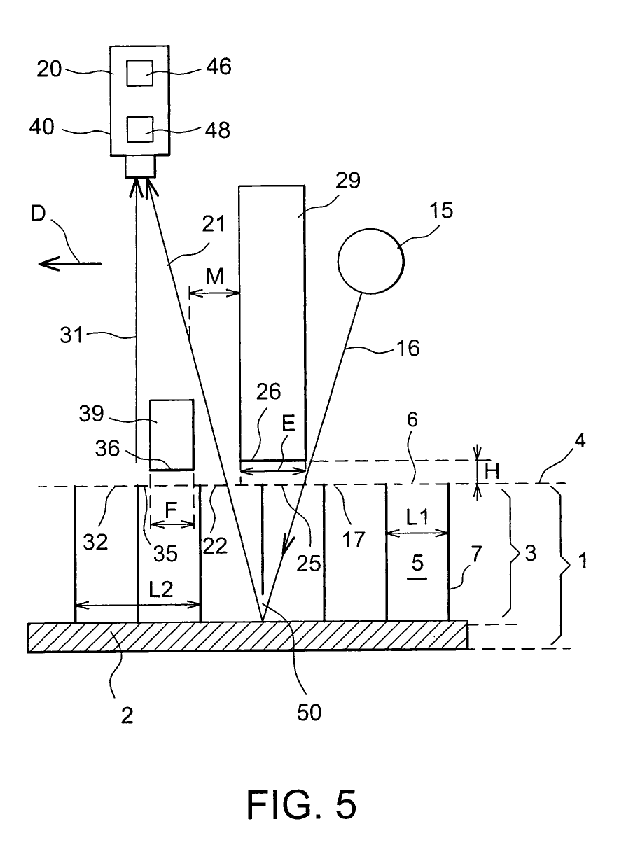

FIG. 5 shows the general principle of an inspection method according to the invention and an inspection instrument 160 according to the invention. Elements identical to elements in the inspection instrument according to prior art are marked with the same numeric references.

FIG. 5 shows a sectional view of a honeycomb 1 comprising a honeycomb core 3 formed from adjacent cells 5 and separated by partitions 7. Said honeycomb core 3 is bonded on one side to a skin 2 and on the other side forms a free surface 4 containing the openings 6 of the cells 5. A bond defect 50 is located between two cells.

An inspection instrument 160 moves along a direction D, with incremental or continuous scanning above the free surface 4 of the honeycomb core 3.

In the same way as the inspection instrument according to prior art, the inspection instrument in FIG. 5 comprises:

a first mask 26 with an illumination edge 27 and an observation edge 28 on which a screen 29 may be fitted, said first mask 26 covering a first intermediate area 25 located between an illuminated area 17 and an observed area 22,

a light source 15 fixed to the first mask 26 that emits incident light 16 illuminating the bottom of the cells 5,

first detection means 20 capable of automatically detecting light 21 emerging from the bottom of the cells 5, said emerging light 21 being derived from incident light 16 that passed through the bond defect 50.

The inspection instrument 160 also comprises:

a second mask 36 on top of which there may be a screen 39, said second mask 36 being fixed to the first mask 26 and located in front of it at a distance M chosen such that emerging light passes between the first mask 26 and the second mask 36 when said two masks 26, 36 move forwards,

retaining means (not shown) to hold the first mask 26 and the second mask 36 at a given height H above the free surface 4, said height H preferably being equal to at least 2 centimeters,

second detection means 40 capable of automatically detecting openings 6 of the cells 5 in a so-called photographed area 32, said photographed area 32 being located in front of the observed area 22, and separated from it by a second intermediate area 35.

The minimum distance between said observed area 22 and said photographed area 32, taken along the direction D, is denoted F and is greater than the width L1 of the openings 6.

The function of the second mask 36 is to act as an obstacle to light that could arrive on the observed area 22. The distance M between the first mask 26 and the second mask 36 is preferably greater than the width L1 of a cell 5, so that light illuminating the photographed area 32 does not arrive in a cell 5 that is currently being observed.

In the example illustrated in FIG. 5, openings 6 are detected by second detection means 40 (arrow 31) with ambient light. As a variant, it could be made by illuminating said cells 5 using an additional light source placed in front of the second mask 36 and fixed to it.

In the example illustrated in FIG. 5, the first automated detection means 20 and the second automated detection means 40 are coincident. For example, they may consist of a camera for continuous scanning of the inspection instrument 160 above the free surface 4, or a still camera for incremental scanning of said inspection instrument 160.

Preferably, the signal processing means 46 and image processing means 48 are associated with the detection means 20, 40. For example, a CCD type camera will be used.

The signal processing means 46 transform signals detected by the detection means 20, 40 into optical images 60a, 60b in the form of matrices of pixels.

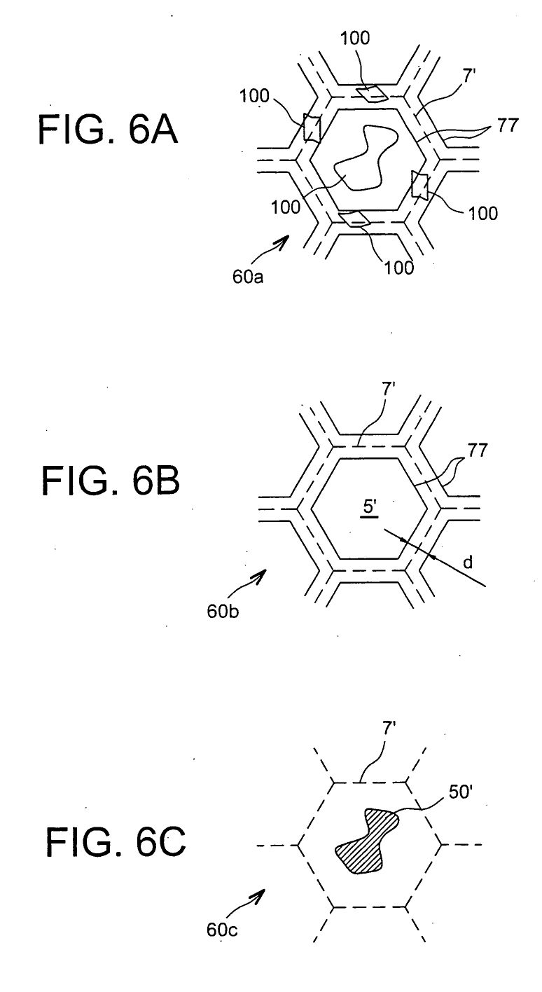

FIG. 6A shows such an optical image 60a obtained by processing of a signal originating from emerging light 21. Spots 100 appear on this optical image 60a. They may correspond to emerging light 21 representative of a bond defect 50 (see FIG. 5). They may also correspond to parasite reflections 18 originating from reflection of incident light 16 on the top edges of partitions 7, in a manner similar to what has been described with reference to FIG. 3 for the variant of the method according to prior art.

FIG. 6B shows another optical image 60b obtained by processing of a signal originating from the openings 6 of the cells 5. Contours 77 can be seen on this photograph type image 60b. These contours correspond to openings 6 of the cells 5 and delimit areas 5′ representative of the cells 5. The distance d between two approximately parallel sections of contours 77 corresponds to the thickness of the partitions 7 separating the cells 5. Lines 7′ are shown in dashed lines, as a theoretical representation of the contours of the cells 5.

The image processing means 48 use the image processing steps of the inspection method. During these steps, which are carried out using calculation means not shown, the optical image 60a containing spots 100 and the optical image 60b containing contours 77 are superposed as shown diagrammatically in FIG. 6A. The position of the spots 100 and the position of the contours 77 are then compared. Spots 100 that are at least partially superposed with an area between two approximately parallel sections of contours 77 are identified as being spots corresponding to parasite reflections 18. A third optical image 60c is then created from which spots corresponding to parasite reflections 18 have been removed, and on which all that remains are spots 50′ that are not at all superposed with areas included between two approximately parallel sections of contours 77, that are representations of the partitions 7. These spots 50′ are then identified as being representative of bond defects 50. The theoretical lines 7′ are also shown in dashed lines on the third optical image 60c, so that the figure is easier to understand.

This type of image 60c makes it easy to see which cells are affected by a bond defect.

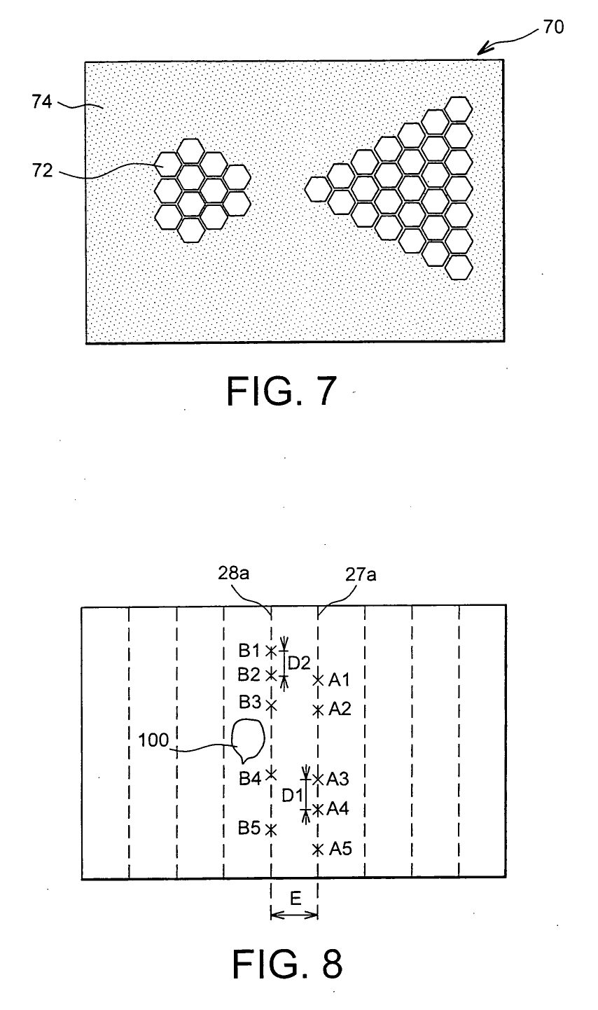

An additional image processing operation creates a resultant optical image on which the presence of bond defects 50 is displayed in a coded manner. FIG. 7 illustrates an example of such a resultant optical image 70. Cells affected by a bond defect are represented in a first color (for example white) and cells not affected by a bond defect are shown in another color (for example grey or black).

An optional variant embodiment of the inspection instrument is shown in FIG. 8. According to this variant, the inspection instrument 160 is such that, for N successive geometric points A on the illumination edge and N successive geometric points B on the observation edge, where N is equal to at least five, the distance AB between the illumination edge and the observation edge is minimal and is equal to E, the distance D1 between two geometric points A being equal to at least 0.5×E, the distance D2 between two geometric points B also being equal to at least 0.5×E, the N geometric points A forming an open line for which the distance between the two geometric points A formed at its ends is greater than the distance between any other pair of geometric points A, the N geometric points B also forming an open line for which the distance between the two geometric points B at its ends is greater than the distance for any other pair of geometric points B.

The invention is not limited to the embodiments that have just been described.

Without going outside the scope of the invention, it would be possible for the first detection means and the second detection means to be separate and connected to each other.

The cells shown in the figures are hexagonal cells. But obviously, the method according to the invention and the inspection instrument according to the invention are suitable for demonstrating bond defects between a honeycomb core and a skin for non-hexagonal cells, for example quadrangular or rounded cells.

In the inspection configuration that has just been described, the light source 15 is behind the first mask 26, the first and second detection means 20, 40 are in front of the first mask 26, and the second mask 36 is in front of the first mask 26. It would be possible to envisage an inverse configuration in which the light source 15 would be in front of the first mask 26, the first and second detection means 20, 40 would be behind the first mask 26 and the second mask 36 would be behind the first mask 26.

Note that the relative positions of the light source for the first and second detection means and the second detection mask with respect to the first mask, are not related to the direction of displacement of the inspection instrument. In other words, the instrument may be moved along the direction D defined as being the direction from the light source to the camera, as indicated in the attached figures, but it could equally well be moved in the opposite direction.

1. Method of inspection of the bond between a honeycomb core and a skin, said honeycomb (1) comprising a honeycomb core (3) composed of adjacent cells (5) delimited laterally by partitions (7), said core (3) being bonded on one side on a skin (2), while at this stage of manufacturing the other side forms a free surface (4) containing the openings (6) of said cells (5), said method comprising the following operations:
use of a light source (15) to illuminate a so-called illuminated area (17) on the free surface (4) of the honeycomb (1) in order to illuminate the inside of cells (5) opening up in said illuminated area (17),
automatically detect emerging light (21) from the cells (5) in a so-called observed area (22) also at said free surface (4),
the minimum distance between said illuminated area (17) and said observed area (22) being denoted (E) and defining a direction (D), and the distance (E) being equal to at least the width (L1) of the openings (6), said width (L1) being measured along the direction (D),
characterized in that it also comprises the operation consisting of:
automatically detecting openings (6) in a so-called photographed area (32), also on said free surface (4).

2. Inspection method according to claim 1, characterized in that the minimum distance between said observed area (17) and said photographed area (32) measured along the direction (D) and denoted (F), is greater than the width (L2) of the openings (6) of two adjacent cells (5).

3. Inspection method according to claim 1, characterized in that openings (6) of the cells (5) in the photographed area (32) are detected automatically with ambient light.

4. Inspection method according to claim 1, characterized in that openings (6) of the cells (5) in the photographed area (32) are detected automatically by illuminating said cells (5) using an additional light source.

5. Inspection method according to claim 1, characterized in that it also includes signal processing operations consisting of:
transforming a signal corresponding to detected emerging light (21) into a first optical image (60a) in the form of a matrix of pixels on which spots (100) appear representing any bond defects (50) and spots (100) representing parasite reflections (18),
transforming a signal corresponding to the detected openings (6) into a second optical image (60b) in the form of a matrix of pixels on which contours (77) appear.

6. Inspection method according to claim 5, characterized in that it also comprises an image processing operation comprising the following steps:
superpose said first optical image (60a) and said second optical image (60b), and identify the spots (100) on the first optical image (60a) that are at least partly superposed with the contours (77) of the second optical image (60b) as being spots (100) representing parasite reflections (18),
provide a third optical image (60c) derived from the first optical image (60a) from which spots (100) identified as being spots representing parasite reflections (18) have been removed.

7. Method according to claim 1, characterized in that it also comprises another optional image processing operation consisting of outputting a resulting optical image (70) that displays bond defects (50) in a coded manner.

8. Method according to claim 7, characterized in that the coded display of bond defects (50) consists of a representation of a top view of the honeycomb (1), on which a first color (74) is assigned to the cells (5) that are not affected by a bond defect (50), and a second color (72) is assigned to cells (5) that are affected by a bond defect (50).

9. Instrument (160) for inspection of the bond between a honeycomb core and a skin, said instrument specially designed to implement the inspection method according to claim 1, said instrument (16) comprising:
a) a first mask (26) delimited laterally by an illumination edge (27) and an observation edge (28) opposite said illumination edge (27),
b) a light source (15) placed behind the first mask (26), said light source (15) being fixed to the first mask (26), said light source (15) producing a beam of incident light (16) in the direction from the back of the first mask (26) towards the front of the first mask (26),
c) first means (20) of automatically detecting emerging light (21) in the direction from the back towards the front of the first mask (26), said first detection means (20) being fixed to the first mask (26), said emerging light (21) passing in front of the observation edge (28),
characterized in that it also comprises:
d) a second mask (36) fixed to the first mask (28) and arranged in front of it at a given distance (M),
e) second means (40) of automatically detecting openings (6) of the cells (5) in front of the second mask (36), said second detection means (40) being fixed to the second mask (36),
f) retaining means to hold said first mask (26) and said second mask (36) at a height (H) above the free surface (4).

10. Inspection instrument (160) according to claim 9, characterized in that the distance (M) between the first mask (26) and the second mask (36) is chosen such that emerging light (21) passes between the first mask (26) and the second mask (36).

11. Inspection instrument (160) according to claim 9, characterized in that the second detection means (40) and the first detection means (20) are coincident.

12. Inspection instrument (160) according to either claim 9 or 11, characterized in that it also comprises an additional light source, designed to illuminate the cells (5) for automatic detection of their openings (6) by the second detection means (40), said additional light source being placed in front of the second mask (36) and fixed to it.

13. Inspection instrument (160) according to claim 9, characterized in that it also comprises signal processing means (46) and image processing means (48) associated with the first and second detection means (20, 40).

14. Inspection instrument (160) according to claim 13, characterized in that said signal processing means (46) are capable of:
transforming a signal corresponding to detected emerging light (21) into a first optical image (60a) in the form of a matrix of pixels on which spots (100) appear representing any bond defects (50) and spots (100) representing parasite reflections (18),
transforming a signal corresponding to the detected openings (6) into a second optical image (60b) in the form of a matrix of pixels on which contours (77) appear.

15. Inspection instrument (160) according to claim 13, characterized in that said image processing means (48) are capable of:
superposing a first optical image (60a) in the form of a matrix of pixels on which spots (100) appear and a second optical image (60b) in the form of a matrix of pixels on which contours (77) appear,
identifying the spots (100) on the first optical image (60a) that are at least partly superposed with the contours (77) as being spots (100) representing parasite reflections (18), and
providing a third optical image (60c) derived from the first optical image (60a) from which spots (100) identified as being spots representing parasite reflections (18) have been removed.

16. Inspection instrument (160) according to claim 15, characterized in that said image processing means (48) are also capable of outputting a resulting optical image (70) that displays bond defects (50) in a coded manner.

17. Inspection instrument (160 according to claim 16, characterized in that the coded display of bond defects (50) consists of a representation of a top view of the honeycomb (1), on which a first color (74) is assigned to the cells (5) that are not affected by, a bond defect (50), and another color (72) is assigned to cells (5) that are affected by a bond defect (50)

18. Inspection instrument (160) according to claim 9, characterized in that it is such that, for N successive geometric points A on the illumination edge (27) and N successive geometric points B on the observation edge (28), where N is equal to at least five, the distance AB between the illumination edge (27) and the observation edge (28) is minimal and is equal to E, the distance D1 between two geometric points A being equal to at least 0.5×E, the distance D2 between two geometric points B also being equal to at least 0.5×E, the N geometric points A forming an open line (27a) for which the distance between the two geometric points A formed at its ends is greater than the distance between any other pair of geometric points A, the N geometric points B also forming an open line (28b) for which the distance between the two geometric points B at its ends is greater than the distance for any other pair of geometric points B.
